(19) United States
(12) Patent Application Publication
(10) Pub. No.: US 2014/0325174 A1
(43) Pub. Date: Oct. 30, 2014

(54) ACCESS CONTROL APPARATUS, ACCESS CONTROL METHOD, AND COMPUTER PROGRAM PRODUCT

(71) Applicant: KABUSHIKI KAISHA TOSHIBA, Tokyo (JP)

(72) Inventors: Masataka Goto, Yokohama-shi (JP); Nobuhiko Sugasawa, Shinagawa-ku (JP); Yuta Kobayashi, Kawasaki-shi (JP); Shinya Murai, Kawasaki-shi (JP)

(73) Assignee: KABUSHIKI KAISHA TOSHIBA, Tokyo (JP)

(21) Appl. No.: 14/202,196

(22) Filed: Mar. 10, 2014

(30) Foreign Application Priority Data
Apr. 26, 2013 (JP) 2013-094198

(51) Int. Cl. G06F 12/14

(52) U.S. Cl. CPC G06F 12/14
USPC 711/163

(57) ABSTRACT

According to an embodiment, an access control apparatus includes a determiner and a controller. The determiner is configured to determine whether an access state of a first device to a storage device satisfies an exclusion criterion for access to the storage device from a second device. The controller is configured to prohibit the access to the storage device from the second device when the access state of the first device satisfies the exclusion criterion.

### CROSS-REFERENCE TO RELATED APPLICATION

This application is based upon and claims the benefit of priority from Japanese Patent Application No. 2013-094198, filed on Apr. 26, 2013; the entire contents of which are incorporated herein by reference.

### FIELD

Embodiments described herein relate to an access control apparatus, an access control method, and a computer program product.

### BACKGROUND

Conventionally, memory cards that are equipped with a communication interface (IF) have been known. For such a memory card, memory access from multiple devices as follows is enabled. One is host memory access from an information processing apparatus (host) to which the memory card is mounted. The other is remote memory access from an information terminal (remote terminal) that is connected to the memory card through communication.

However, in conventional techniques, mutual exclusion has not been performed appropriately on the access to a single storage device from multiple devices. Therefore, data or a file system in the storage device can be damaged in conventional techniques.

### BRIEF DESCRIPTION OF THE DRAWINGS

FIGS. 1A and 1B illustrate configuration examples of a data system according to an embodiment;

FIG. 2 illustrates a configuration example of an access control apparatus according to the embodiment;

FIG. 3 illustrates a configuration example of an access control function according to the embodiment;

FIG. 4 is a sequence diagram illustrating an example (I) of a processing procedure at the time of access control according to the embodiment;

FIG. 5 is a sequence diagram illustrating an example (II) of the processing procedure at the time of access control according to the embodiment;

FIG. 6 is a sequence diagram illustrating an example (III) of the processing procedure at the time of access control according to the embodiment; and

FIG. 7 is a sequence diagram illustrating an example (IV) of the processing procedure at the time of access control according to the embodiment.

### DETAILED DESCRIPTION

According to an embodiment, an access control apparatus includes a determiner and a controller. The determiner is configured to determine whether an access state of a first device to a storage device satisfies an exclusion criterion for access to the storage device from a second device. The controller is configured to prohibit the access to the storage device from the second device when the access state of the first device satisfies the exclusion criterion.

Embodiments of an access control apparatus, an access control method, and an access control program are explained in detail below with reference to the accompanying drawings.

System Configuration

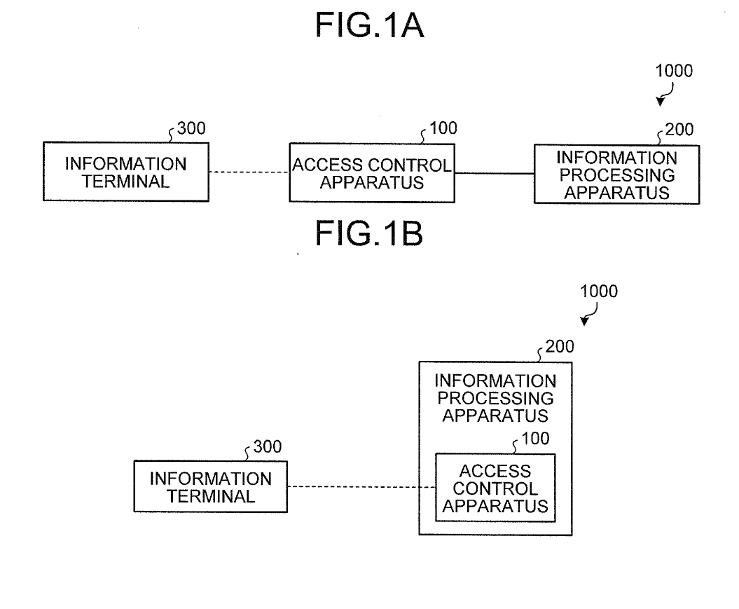

FIGS. 1A and 1B illustrate configuration examples of a data system 1000 according to an embodiment. Access from multiple devices to a single storage device is considered to be performed, for example, in a data system 1000 as illustrated in FIGS. 1A and 1B. FIG. 1A illustrates an example in which an access control apparatus 100 that performs access control for a storage device is connected to an information processing apparatus 200 through a data transmission path, and an information terminal 300 performs remote access to the access control apparatus 100. FIG. 1B illustrates an example in which the access control apparatus 100 that performs access control for the storage device is inserted through an insertion slot to the information processing apparatus 200, and the information terminal 300 performs remote access to the access control apparatus 100.

The access control apparatus 100 according to the present embodiment includes a device IF and a communication IF, and controls access to the storage device from the information processing apparatus 200 and remote access to the storage device from the information terminal 300. In the present embodiment, the access control apparatus 100 does not need to have a storage device such as a memory (a storage device is not required to be equipped therein). For example, it is acceptable if the access control apparatus 100 is equipped with an IF compatible with the storage device, and the information processing apparatus 200 and the information terminal 300 can access to the storage device through the access control apparatus 100.

The information processing apparatus 200 according to the present embodiment is, for example, a personal computer (PC) that has a device IF, and the like. The information processing apparatus 200 is connected to the access control apparatus 100 through the device IF (hereinafter, “host access”). As a method of the host access, there are a method using a universal serial bus (USB) cable, a method of directly connecting a device, and the like. Accordingly, the device IF to be equipped is an interface that supports the host access method.

The information terminal 300 according to the present embodiment is, for example, a tablet terminal that has a communication IF, and the like. The information terminal 300 performs remote access to the access control apparatus 100 through the communication IF. As a method of the remote access, there is a method of directly accessing data in the storage device from an operating system (OS) of the information terminal 300 (hereinafter, “block device access”). For example, block access of a small computer system interface (SCSI) represents this method. Moreover, as another method of the remote access, there is a method of accessing a file in the storage device through a file system in the storage device (hereinafter, “network device access”). For example, a method using a file transfer protocol (FTP) or the like represents this method. Accordingly, the communication IF to be equipped is an interface that supports the communication method or the access method. In the present embodiment, the communication distance does not matter.

As described, in the data system 1000 according to the present embodiment, the storage device that is controlled by the access control apparatus 100 can be accessed from multiple input systems such as the information processing apparatus 200 and the information terminal 300 to perform data processing such as read and write.

Apparatus Configuration

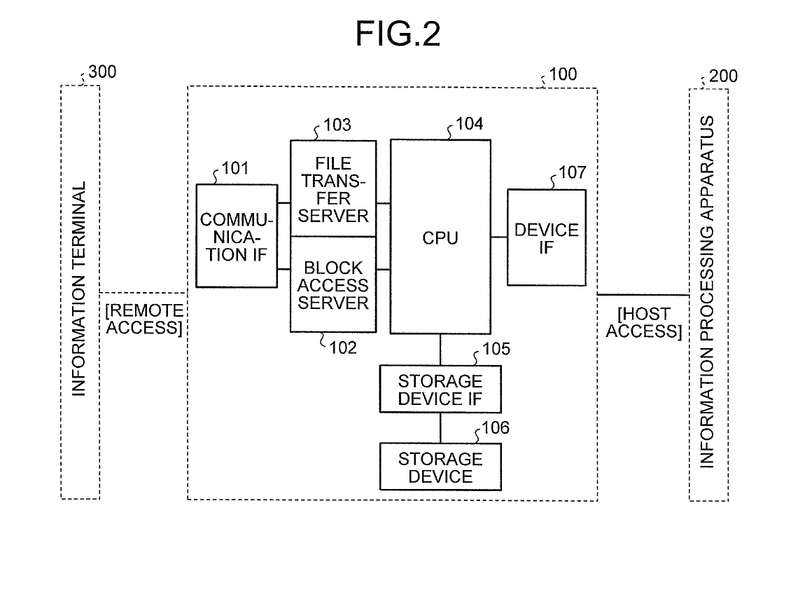

FIG. 2 illustrates a configuration example of the access control apparatus 100 according to the present embodiment. In the explanation below, the access control apparatus 100 that includes a storage device is used for convenience sake.

As illustrated in FIG. 2, the access control apparatus 100 according to the present embodiment includes a communication IF 101, a block access server 102, a file transfer server 103, and the like. Furthermore, the access control apparatus 100 includes a central processing unit (CPU) 104, a storage device IF 105, a storage device 106, a device IF 107, and the like. To the access control apparatus 100, each hardware is connected through a bus, and transmission and reception of data are performed therein.

The communication IF 101 is an interface to perform communication with external devices through a predetermined communication mode. The communication mode includes TransferJet (registered trademark), WiFi, and the like. By such a method, the access control apparatus 100 accepts remote access from the information terminal 300, which is an external device.

The block access server 102 is a device that provides a server function for the block device access to a client of an external device that can perform remote access through the communication IF 101. The block access server 102 provides, for example, a server function (block-device access function) of iSCSI used in a transmission control protocol/Internet protocol (TCP/IP) or an SCSI profile of TransferJet (registered trademark). The block access server 102 accesses the storage device 106 through the CPU 104 in accordance with a request message relating to block access from the external device.

The block-device access function is to enable an external device to perform data access based on sectors through communication. As a communication protocol used therein, iSCSI that is what SCSI standardized by T10 is expanded for TCP/IP communication, the SCSI profile of TransferJet (registered trademark) using SCSI messages, and the like have been known. In the block device access function, a file system of the OS being in operation in the external device controls while communication between a block access client (not illustrated) in the external device and the block access server 102 is established.

The file transfer server 103 is a device that provides a server function for file transfer (network-device access function) to a client of an external device that can perform remote access through the communication IF 101. The file transfer server 103 provides, for example, a server function of FTP (RFC-959) or object exchange (OBEX).

The network-device access function is to perform transmission and reception of data in a file unit. As a communication protocol used therein, FTP that is standardized for TCP/IP communication in RFC-959, an OBEX protocol of TransferJet (registered trademark), and the like have been known. In the network-device access function, communication of control messages relating to transmission and reception of a file and communication of file data are performed between a file transfer client (not illustrated) in the external device and the file transfer server 103, and thus files are communicated. The file control at the time of network device access in the access control apparatus 100 is performed by a file system in the access control apparatus 100.

The CPU 104 is a control device to achieve control of the entire apparatus or installed functions. The storage device IF 105 is an interface to perform various kinds of data processing on the storage device. The storage device IF 105 converts access (read/write) in a block unit from the CPU 104 into an access procedure for the storage device 106. The storage device 106 stores programs and data in a storage region. The storage device includes a volatile one and a nonvolatile one. The volatile storage device 106 is, for example, a memory such as a static random access memory (SRAM) and a dynamic RAM (DRAM), and programs and data are read to be temporarily held therein. The nonvolatile storage device 106 is, for example, a storage medium including a flash memory such as a secure digital (SD) memory card, and a platter of a hard disk drive (HDD), and programs and data are permanently stored. Therefore, for example, the CPU 104 reads a program or data from a storage medium to the memory to perform processing, and thereby control of the entire apparatus and the installed functions are achieved. The access control function and the file system according to the present embodiment are implemented by such a method.

The device IF 107 is an interface to enable a device to perform the host access. The device IF 107 provides, for example, a function acting as a general-purpose storage called mass storage class (MSC) in the case of interface compatible with a USB. This enables a device-connected equipment to access to a storage region of the device to which the host access is possible through the device IF 107 as to an HDD. The device IF 107 receives a request for the block access from a device-connected equipment, interprets contents of the request, and accesses the storage device 106 through the CPU 104. Thus, the access control apparatus 100 accepts the host access from the information processing apparatus 200 being the device-connected equipment.

As described above, in the access control apparatus 100 according to the present embodiment, an access control function that controls access to the storage device 106 from multiple devices can be provided with the configuration described above.

Access Control Function

An access control function according to the present embodiment is to be explained. The access control apparatus 100 determines whether an access state of a device that is currently accessing the storage device 106 is such a state that access from another device to the storage device 106 should be excluded. When the access state of the device that is currently accessing is the state requiring exclusion, the access control apparatus 100 prohibits access to the storage device 106 from another device. The access control apparatus 100 according to the present embodiment has such an access control function.

For a memory card having the communication IF 101, access to data in the memory from multiple devices (through multiple interfaces) is possible. Therefore, for the memory card having the communication IF 101, mutual exclusion for access among devices (among interfaces) is required to be guaranteed at a file system level. Specifically, it is necessary to ensure consistency in contents of files and file management data.

A problem can occur, for example, when an external device performs remote access to a memory card during the host access by a device-connected equipment that mounts the memory card having the communication IF 101 to the memory card. For this, a method of prohibiting remote access during host access can be considered. However, the host access is performed in a block unit. Therefore, it is difficult to determine access breaks in a file unit on the memory card side. In addition, because some device-connected equipments perform data processing using a buffer cash, it is difficult to achieve appropriate mutual exclusion with exclusion control based simply on access frequency or access intervals.

As described, in conventional techniques, mutual exclusion is not appropriately performed for access from multiple devices to the single storage device 106, and this could lead to corruption of data (corruption of a file system) in the storage device 106.

Therefore, the access control function according to the present embodiment is arranged such that whether a state of access from a device is in such a state requiring exclusion is determined based on access breaks in a file unit corresponding to a type of access as a determination criterion, and exclusion control is performed on access from multiple devices based on the result of determination.

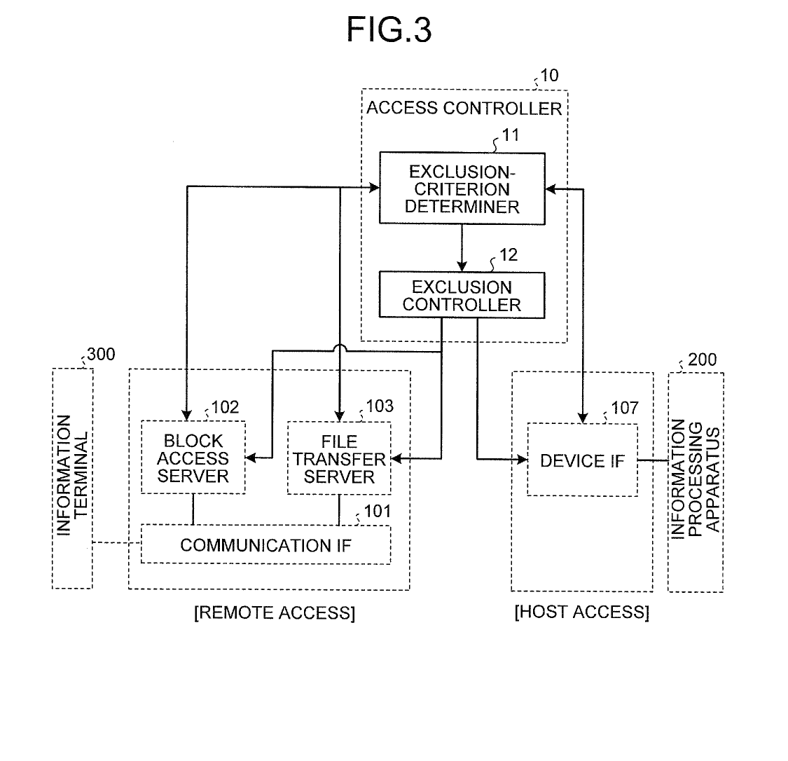

A configuration and an operation of the access control function according to the present embodiment are explained below. FIG. 3 illustrates a configuration example of the access control function according to the present embodiment. As illustrated in FIG. 3, the access control function according to the present embodiment is implemented by an access controller 10 that includes an exclusion-criterion determiner 11, an exclusion controller 12, and the like.

The exclusion-criterion determiner 11 according to the present embodiment is a functional unit that determines whether an access state of a device (first device) that is currently accessing the storage device 106 is such a state that access to the storage device 106 from another device (second device) should be excluded. The exclusion-criterion determiner 11 determines whether it is the state that access to the storage device 106 from another device should be excluded by determining whether the access state of the device that is currently accessing the storage device 106 satisfies an exclusion criterion defined in advance.

The exclusion criterion according to the present embodiment is to be explained. In the exclusion criterion according to the present embodiment, access breaks in a file unit corresponding to types of access from a device are defined. Specifically, as follows.

Exclusion Criterion at Host Access

An exclusion criterion at host access is a criterion that when the access control apparatus 100 inquires the state to the device IF 107, the state responded by the device IF 107 is such a state that access through the communication IF 101 should be excluded. In the present embodiment, following two criteria are adopted.

[Exclusion Criterion 1]: Exclusion criterion 1 is a criterion that when a response from the device IF 107 indicates an ejection prohibited state, it is the state that access from the information terminal 300 should be excluded. The ejection prohibited state corresponds to, for example, a mount state to an OS, and signifies a state where the storage device 106 is under control of the OS operating on the information processing apparatus 200 and disconnection therefrom is prohibited. Therefore, the ejection prohibited state indicates a state where the information processing apparatus 200 is performing host access to the storage device 106 (data is being read or written) through the device IF 107 and the storage device IF 105. On the other hand, an ejection allowed state corresponds to a state where the mount state is released from the OS (unmount state) and the like, and signifies a state where the storage device 106 has been released from the control of the OS operating on the information processing apparatus 200 and disconnection is allowed. Therefore, the ejection allowed state indicates a state where the information processing apparatus 200 has ended host access to the storage device 106 (reading and writing of a file is finished) through the device IF 107 and the storage device IF 105. As described, in the present embodiment, the ejection prohibited state enabling to determine an access break in a file unit is adopted as an exclusion criterion at host access.

[Exclusion Criterion 2]: Exclusion criterion 2 at host access is a criterion that even if a response from the device IF 107 indicates the ejection allowed state, it is the state that access from the communication terminal 101 should be excluded. More specifically, in the ejection allowed state, when it is such a state that time equal to or longer than a time interval of a successive data writing operation has not elapsed since last data writing in successive data writing that has been performed during host access, it is the state requiring exclusion. Exclusion criterion 2 is a criterion to accommodate the OS that performs data writing even after the ejection allowed state is responded (data writing has not been finished even in the ejection allowed state). In the present embodiment, determination of elapsed time described above is performed, setting a threshold to a time twice as long as a time interval of a successive data writing operation. The threshold is not limited thereto. The threshold can be set according to a data writing property of the OS. As described, in the present embodiment, according to a data writing property of an OS, a state enabling to determine completion of data writing is adopted as an exclusion criterion at host access.

Exclusion Criterion at Remote Access

An exclusion criterion at remote access is a criterion that when the access control apparatus 100 inquires the state to the block access server 102 or the file transfer server 103, the state responded by the respective servers 102 and 103 is such a state that access through the device IF 107 should be excluded. In the present embodiment, a following criterion is adopted.

[Exclusion Criterion]: Exclusion criterion at remote access is a criterion that when a response from the block access server 102 or the file transfer server 103 indicates a state in which a session is established (session established state), it is the state that access from the device IF 107 should be excluded. The session established state corresponds to, for example, a communication enabled state, and signifies a state where a communication session to perform remote access to the storage device 106 is established and disconnection of the established session is prohibited. Therefore, the session established state indicates a state where the information terminal 300 is performing remote access to the storage device 106 (a file is being read or written) through the communication IF 101 and the storage device IF 105. More specifically, it indicates a state between start and end of connection, or a state between start and end of a file reading/writing request (in the case of FTP, while a put command and a get command are being issued).

The exclusion criteria described above are stored in a predetermined storage region in advance as data that can be referred by the exclusion-criterion determiner 11. Thus, the exclusion-criterion determiner 11 refers to the above exclusion criteria in data, and determines whether a state of access from a device satisfies a predefined criterion for each access type based on a state responded by the block access server 102, the file transfer server 103, or the device IF 107.

The exclusion controller 12 according to the present embodiment is a functional unit that performs exclusion control on access from a device based on the result of determination with the exclusion criteria. The exclusion controller 12 performs exclusion control on host access to the storage device 106 from the information processing apparatus 200 and remote access to the storage device 106 from the information terminal 300.

The exclusion controller 12 performs exclusion control on access from a device when the access state of the device is a state requiring exclusion. The exclusion controller 12 prohibits remote access from the information terminal 300 when the access state of the information processing apparatus 200 is in a state requiring exclusion. Moreover, the exclusion controller 12 prohibits host access when the access state of the information terminal 300 is in a state requiring exclusion.

The exclusion controller 12 instructs the block access server 102 or the file transfer server 103, when the access state of the information processing apparatus 200 is in a state requiring exclusion, exclusion processing to prohibit connection. As a result, the communication IF 101 notifies prohibition of remote access (notification that remote access is prohibited) as a control result to the information terminal 300 that has sent an access request. Furthermore, the exclusion controller 12 instructs the device IF 107, when the access state of the information terminal 300 is a state requiring exclusion, exclusion processing to prohibit access. As a result, the device IF 107 notifies prohibition of host access (notification that host access is prohibited) as a control result to the information processing apparatus 200 that has sent an access request.

As described, in the access control function according to the present embodiment, appropriate mutual exclusion is performed on access from multiple devices to the single storage device 106 by performing exclusion control using access breaks in a file unit as a determination criterion.

As described above, the access control function according to the present embodiment is implemented by executing an access control program on the access control apparatus 100 so that the respective functional units described above operate in cooperation.

The access control program according to the present embodiment is installed in the storage device 106 such as a read only memory (ROM) included in the access control apparatus 100 as an execution environment to be provided. The access control program has a modular configuration including the respective functional units described above. The program is read by the CPU 104 from the ROM to be executed, and thereby the respective functional units are created on the RAM. The method of providing the access control program is not limited thereto. For example, such a method that the access control apparatus is store in a device connected to the Internet and the like, and is downloaded through a network can be applied. Alternatively, a method that the access control program is recorded on a storage medium readable by the access control apparatus 100 in a file in an installable form or in an executable form to be provided as a computer program product can also be applied.

Processing (cooperative operation of the respective functional units) performed when the access control program is executed is explained below using sequence diagrams.

Processing at Host Access

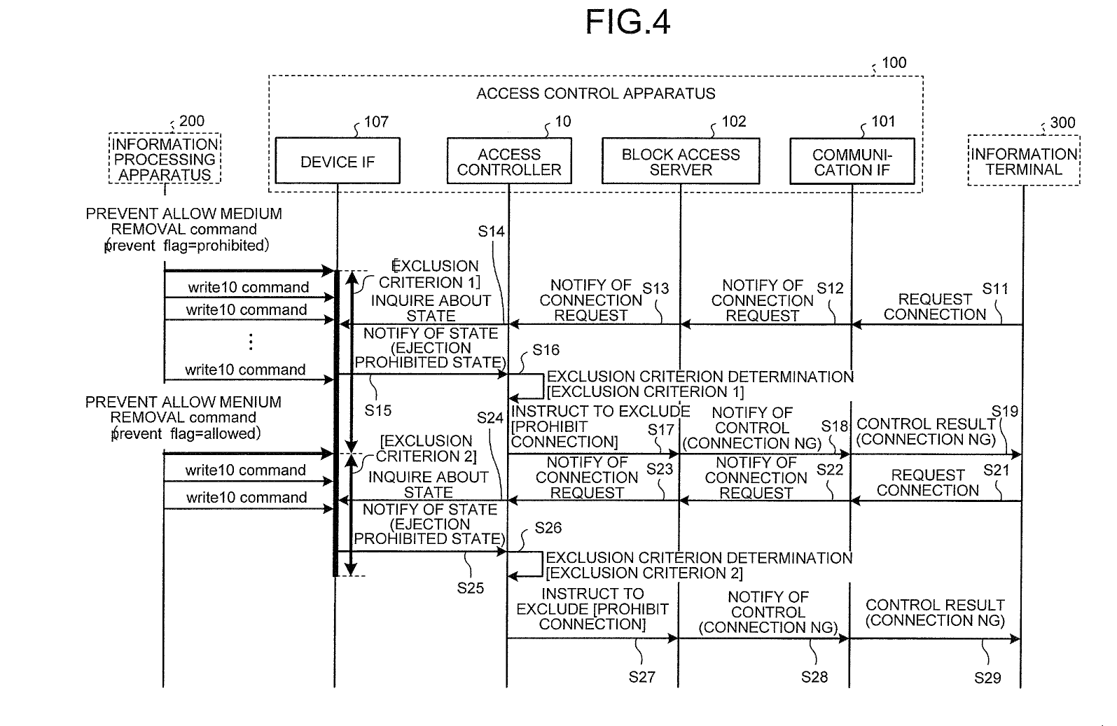

FIG. 4 is a sequence diagram illustrating an example (I) of a processing procedure at the time of access control according to the present embodiment. In FIG. 4, a state where the information processing apparatus 200 is performing host access to the storage device 106 through the device IF 107 is illustrated. Furthermore, in FIG. 4, an example when block device access is performed from the information terminal 300 during the host access from the information processing apparatus 200 is illustrated. The subject period of exclusion processing with [Exclusion Criterion 1] illustrated in the diagram is a period in the ejection prohibited state. Moreover, the subject period of exclusion processing with [Exclusion Criterion 2] illustrated in the diagram is a period in a state where time equal to longer than an operation time interval in successive data writing has not elapsed after transition from the eject prohibited state to the ejection allowed state.

[Exclusion Criterion 1]: As illustrated in FIG. 4, upon receiving a connection request (REQUEST CONNECTION) from the information terminal 300 during host access of the information processing apparatus 200 (step S11), the access control apparatus 100 according to the present embodiment performs the following processing. The communication IF 101 notifies the access controller 10 of reception of the connection request through the block access server 102 (steps S12, S13).

In response to this, the access controller 10 inquires the device IF 107 about a state (step S14), and requests a response about the state. Consequently, the device IF 107 notifies the access controller 10 that it is in the ejection prohibited state due to host access (step S15) to respond the state. At this time, the device IF 107 determines that it is in the ejection prohibited state based on a prevent flag (attribute value) of the PREVENT ALLOW MEDIUM REMOVAL command that is received from the information processing apparatus 200 being “prohibited”.

The access controller 10 makes the exclusion-criterion determiner 11 refer to [Exclusion Criterion 1] corresponding to host access, and determine whether the access state of the information processing apparatus 200 satisfies the exclusion criterion based on the eject prohibited state responded by the device IF 107 (step S16). At this time, the exclusion-criterion determiner 11 determines, when the access state of the information processing apparatus 200 is the ejection prohibited state, that it is in a state requiring exclusion.

As a result, when it is determined that the access state of the information processing apparatus 200 is the ejection prohibited state and is a state requiring exclusion, the access controller 10 makes the exclusion controller 12 instruct exclusion processing of prohibiting connection to the block access server 102 (step S17).

In response to this, the block access server 102 notifies of unavailable connection indicating that remote access is prohibited (hereinafter, referred to as connection NG) as a control result to the information terminal 300 that has requested connection, through the communication IF 101 (steps S18, S19). At this time, the block access server 102 notifies the communication IF 101 that the information terminal 300 is not to be connected by suspending processing with a busy response or no response, besides an error response such as the notification of connection NG.

[Exclusion Criterion 2]: As illustrated in FIG. 4, upon receiving a connection request from the information terminal 300 during host access of the information processing apparatus 200 (step S21), the access control apparatus 100 according to the present embodiment performs the following processing. The communication IF 101 notifies the access controller 10 of reception of the connection request through the block access server 102 (steps S22, S23).

In response to this, the access controller 10 inquires the device IF 107 about a state (step S24), and requests a response about the state. Consequently, the device IF 107 notifies the access controller 10 that it is in the ejection allowed state as the host access is ended (step S25) to respond the state. At this time, the device IF 107 determines that it is in the ejection allowed state based on the prevent flag (attribute value) of the PREVENT ALLOW MEDIUM REMOVAL command that is received from the information processing apparatus 200 being “allowed”.

The access controller 10 makes the exclusion-criterion determiner 11 refer to [Exclusion Criterion 2] corresponding to host access, and determine whether the access state of the information processing apparatus 200 satisfies the exclusion criterion based on the eject allowed state responded by the device IF 107 (step S26). The exclusion-criterion determiner 11 determines, in the case of the ejection allowed state, whether time equal to or longer than a time interval of a successive data writing operation has elapsed since last data writing in successive data writing that has been performed during the host access. Moreover, the exclusion-criterion determiner 11 determines whether time equal to or longer than the time interval of the successive data writing operation has elapsed since last data writing based on a threshold set according to data writing properties of the OS. At this time, the exclusion-criterion determiner 11 determines, when the access state of the information processing apparatus 200 is the ejection allowed state but the elapsed time is shorter than the threshold, that it is in a state requiring exclusion.

As a result, when it is determined that the access state of the information processing apparatus 200 is the ejection allowed state and the elapsed time is shorter than the threshold being a state requiring exclusion, the access controller 10 makes the exclusion controller 12 instruct exclusion processing of prohibiting connection to the block access server 102 (step S27).

In response to this, the block access server 102 notifies of connection NG as a control result to the information terminal 300 that has requested connection, through the communication IF 101 (steps S28, S29).

When accessed by the information terminal 300 by network device access (when remote-accessed through a file system) during host access of the information processing apparatus 200, the access controller 10 performs the processing described above on the file transfer server 103.

As described, the access control apparatus 100 according to the present embodiment, upon identifying a state satisfying an exclusion criterion during host access of the information processing apparatus 200, prohibits remote access such as block device access or network device access from the information terminal 300.

Processing 1 at Remote Access

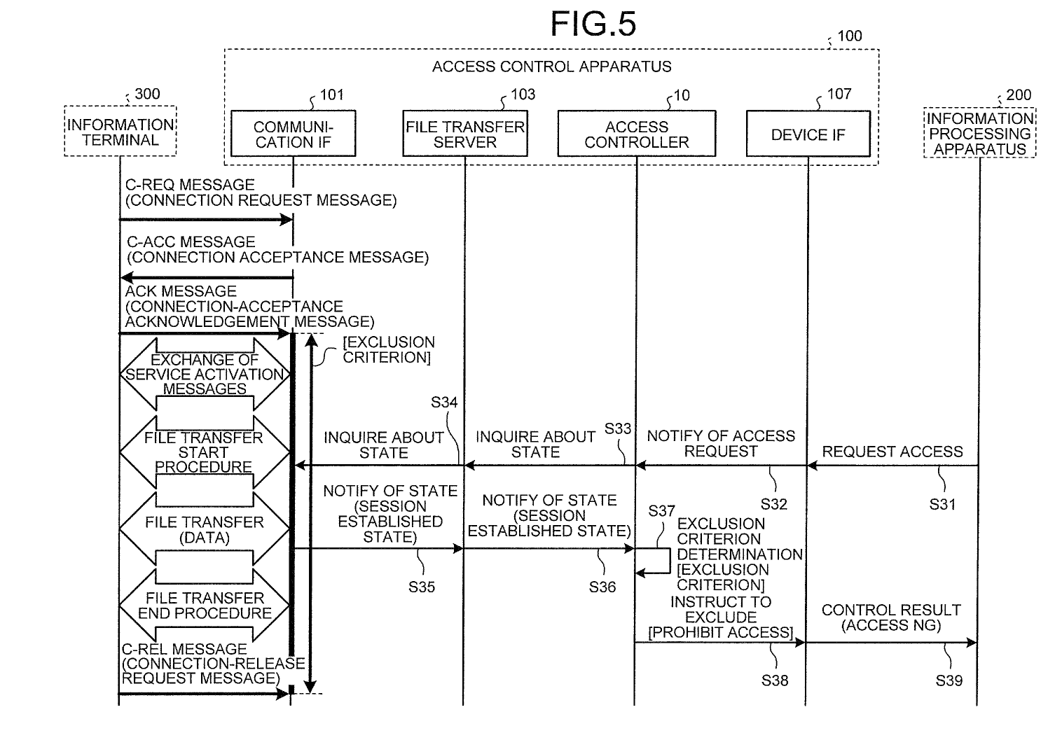

FIG. 5 is a sequence diagram illustrating an example (II) of the processing procedure at the time of access control according to the present embodiment. In FIG. 5, a state where the information terminal 300 is performing remote access to the storage device 106 through the communication IF 101 is illustrated. Furthermore, in FIG. 5, an example when host access is performed from the information processing apparatus 200 during network device access from the information terminal 300 is illustrated. The subject period of exclusion processing with [Exclusion Criterion] illustrated in the diagram is a period in the session established state.

As illustrated in FIG. 5, upon receiving an access request from the information processing apparatus 200 during network device access of the information terminal 300 (step S31), the access control apparatus 100 according to the present embodiment performs the following processing. The device IF 107 notifies the access controller 10 of reception of the access request (step S32).

In response to this, the access controller 10 inquires the communication IF 101 about a state through the file transfer server 103 (steps S33, S34), and requests a response about the state. Consequently, the communication IF 101 notifies the access controller 10 through the file transfer server 103 that it is in the session established state by network device access (steps S35, S36) to respond the state. At this time, the file transfer server 103 determines that it is in the session established state based on a connection-acceptance acknowledgement message (ACK message) that is received from the information terminal 300 through the communication IF 101.

The access controller 10 makes the exclusion-criterion determiner 11 refer to [Exclusion Criterion] corresponding to remote access, and determine whether the access state of the information terminal 300 satisfies the exclusion criterion based on the session established state responded by the file transfer server 103 (step S37). At this time, the exclusion-criterion determiner 11 determines, when the access state of the information terminal 300 is the session established state, that it is in a state requiring exclusion.

As a result, when it is determined that the access state of the information terminal 300 is the session established state and is a state requiring exclusion, the access controller 10 makes the exclusion controller 12 instruct exclusion processing of prohibiting access to the device IF 107 (step S38).

In response to this, the device IF 107 notifies of access NG (that host access is prohibited) as a control result to the information processing apparatus 200 that has requested access (step S39).

When accessed by another information terminal by block device access (when accessed through a second communication mode) during network device access (during access through a first communication mode) of the information terminal 300, the access controller 10 performs the processing described above on the block access server 102. On the other hand, when accessed by another information terminal by network device access during block device access of the information terminal 300, the access controller 10 performs the processing described above on the file transfer server 103.

As described, the access control apparatus 100 according to the present embodiment, upon identifying a state satisfying an exclusion criterion during remote access of the information terminal 300, prohibits host access from the information processing apparatus 200. In addition, the access control apparatus 100 according to the present embodiment, upon identifying a state of performing remote access by either one of block device access and network device access from the information terminal 300 satisfying an exclusion criterion (when remote-accessed through different modes by multiple devices), prohibits remote access of the other.

Processing 2 at Remote Access

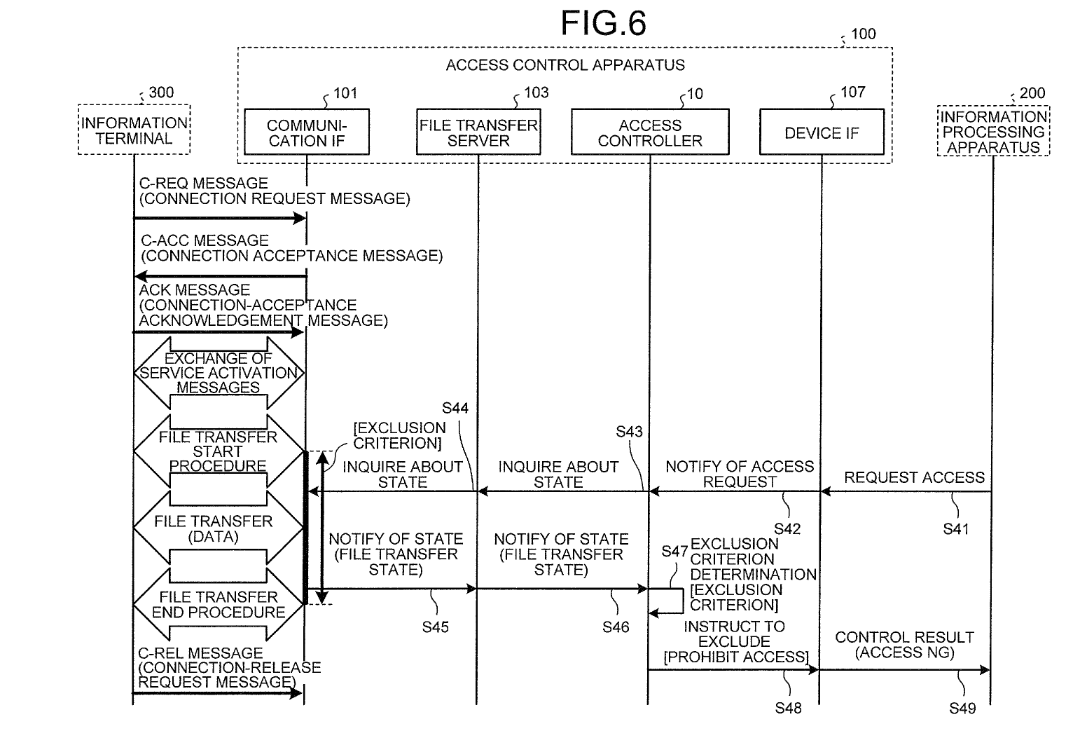

Although an example in which the period (period in the session established state) from the reception of the connection-acceptance acknowledgement message from the information terminal 300 by the access control apparatus 100 until the reception of a connection-release request message (C-REL message) is regarded as the subject period of exclusion processing has been illustrated in FIG. 5, it is not limited thereto. The subject period of exclusion processing can be, for example, a period illustrated in FIG. 6.

FIG. 6 is a sequence diagram illustrating an example (III) of the processing procedure at the time of access control according to the present embodiment. In FIG. 6, a state where the information terminal 300 is performing remote access to the storage device 106 through the communication IF 101 is illustrated. Furthermore, in FIG. 6, an example when host access is performed from the information processing apparatus 200 during network device access from the information terminal 300 is illustrated. The subject period of exclusion processing with [Exclusion Criterion] illustrated in the diagram is a period in a state of transferring a file (hereinafter, “file transfer state”).

As illustrated in FIG. 6, upon receiving an access request from the information processing apparatus 200 during network device access of the information terminal 300 (step S41), the access control apparatus 100 according to the present embodiment performs the following processing. The device IF 107 notifies the access controller 10 of reception of the access request (step S42).

In response to this, the access controller 10 inquires the communication IF 101 about a state through the file transfer server 103 (steps S43, S44), and requests a response about the state. Consequently, the communication IF 101 notifies the access controller 10 through the file transfer server 103 that it is in the file transfer state by network device access (steps S45, S46) to respond the state. At this time, the file transfer server 103 determines that it is in the file transfer state based on a file-transfer start procedure that is received from the information terminal 300 through the communication IF 101.

The access controller 10 makes the exclusion-criterion determiner 11 refer to [Exclusion Criterion] corresponding to remote access, and determine whether the access state of the information terminal 300 satisfies the exclusion criterion based on the file transfer state responded by the file transfer server 103 (step S47). At this time, the exclusion-criterion determiner 11 determines, when the access state of the information terminal 300 is the file transfer state, that it is in a state requiring exclusion.

As a result, when it is determined that the access state of the information terminal 300 is the file transfer state and is a state requiring exclusion, the access controller 10 makes the exclusion controller 12 instruct exclusion processing of prohibiting access to the device IF 107 (step S48).

In response to this, the device IF 107 notifies of access NG (that host access is prohibited) as a control result to the information processing apparatus 200 that has requested access (step S49).

As described, a subject period of exclusion processing at remote access according to the present embodiment can be a period from start until end of file transfer. In other words, a subject period of exclusion processing at remote access can be shortened to a communication period of data in which a file is actually communicated, instead of a period while a session is established. Thus, the access control apparatus 100 according to the present embodiment performs mutual exclusion on access to the single storage device 106 from multiple devices efficiently.

As described, the access control apparatus 100 according to the present embodiment performs exclusion control on access from multiple devices, using access breaks in a file unit according to access types as a determination criterion, and based on a result of determination whether an access state from a device is in a state requiring exclusion. Thus, the access control apparatus 100 can perform mutual exclusion on access to the single storage device 106 from multiple devices appropriately.

Processing Based on Priority Setting

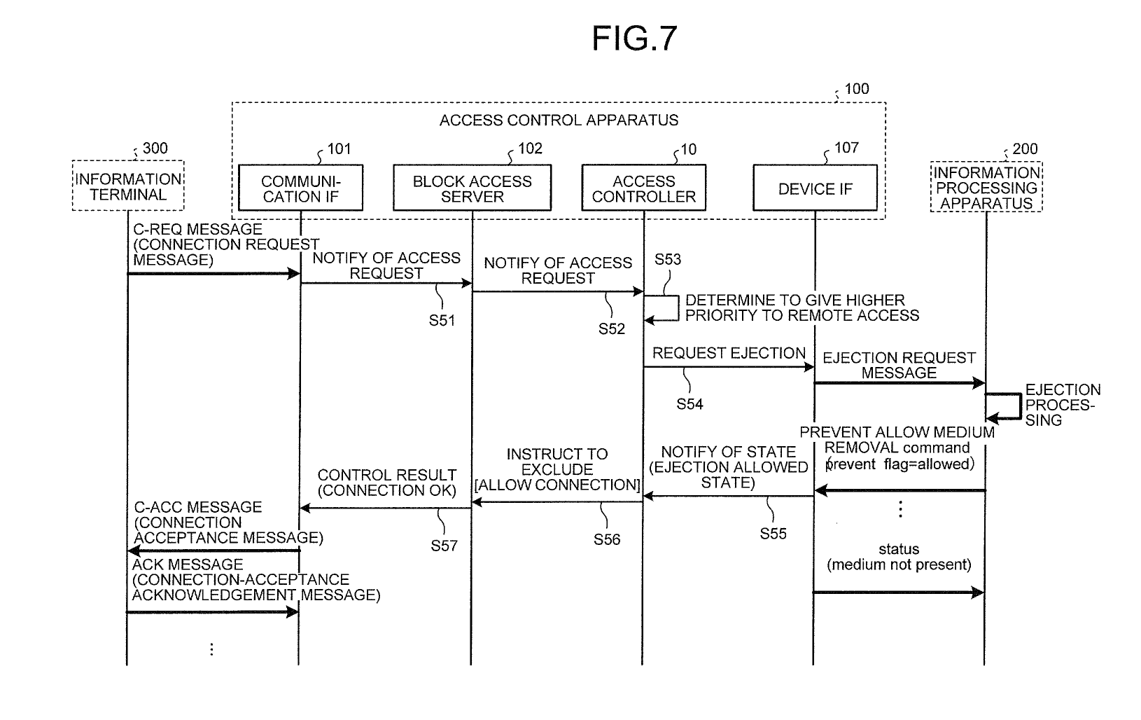

The access control apparatus 100 according to the present embodiment can have, for example, an access control function in which remote access from the information terminal 300 receives higher priority than host access from the information processing apparatus 200 as illustrated in FIG. 7.

FIG. 7 is a sequence diagram illustrating an example (IV) of the processing procedure at the time of access control according to the present embodiment. In FIG. 7, an example where when a connection request from the information terminal 300 by block device access is received, the access control apparatus 100 gives higher priority to the block device access than host access from the information processing apparatus 200 is illustrated.

As illustrated in FIG. 7, upon receiving a connection request message (C-REQ message) from the information terminal 300, the access control apparatus 100 according to the present embodiment performs the following processing. The communication IF 101 notifies the access controller 10 of reception of the connection request through the block access server 102 (steps S51, S52).

In response to this, the access controller 10 determines to give higher priority to the remote access from the information terminal 300 than the host access from the information processing apparatus 200 based on preset priority sequence (step S53). At this time, the access controller 10 makes a determination based on priority setting information in which a priority sequence to determine which access out of host access from the information processing apparatus 200 and remote access from the information terminal 300 is given higher priority.

Consequently, the access control apparatus 100 sends an ejection request to the information processing apparatus 200 through the device IF 107 (step S54). At this time, the access controller 10 requests ejection to the information processing apparatus 200 by issuing a message requesting release of the storage device 106 from control of the OS.

Thereafter, ejection processing is performed in the information processing apparatus 200, and when the processing is completed, the ejection allowed state is notified to the access control apparatus 100.

In response to this, the device IF 107 notifies that it is in the ejection allowed state to the access controller 10 (step S55), and responds the state of the information processing apparatus 200 in response to the ejection request.

As a result, the access controller 10 makes the exclusion controller 12 instruct exclusion processing for allowing connection to the block access server 102 (step S56).

In response to this, the block access server 102 notifies the communication IF 101 of connection OK (that remote access is allowed) as a control result (step S57).

Thereafter, in the access control apparatus 100, a connection acceptance message (C-ACC message) is responded to the information terminal 300 that has requested connection through the communication IF 101, and a communication session between the information terminal 300 and the access control apparatus 100 is established.

As described, the access control apparatus 100 can have an access control function of performing exclusion control on access to the storage device 106 from devices based on the priority sequence among accesses. Thus, the access control apparatus 100 according to the present embodiment can perform access control such that access having higher access frequency to the storage device 106 is given higher priority out of host access and remote access, for example, and thereby convenience can be enhanced.

As described, according to the access control apparatus 100 of the present embodiment, it is determined, by the exclusion-criterion determiner 11, whether the access state of a device that is currently accessing the storage device 106 is a state where access to the storage device 106 from another device should be excluded. The access control apparatus 100 prohibits access to the storage device 106 from another device when the access state of the device currently accessing is the state requiring exclusion by the exclusion controller 12.

Thereby, the access control apparatus 100 according to the present embodiment provides a system to perform appropriate mutual exclusion on access to the single storage device 106 from multiple devices. As a result, the access control apparatus 100 according to the present embodiment can preserve consistency of contents of files and file management data in the storage device 106 that is being accessed by multiple devices, and can prevent data corruption (corruption of a file system in the storage device 106 can be prevented).

Although explanation has been given using block device access and network device access for remote access from the information terminal 300, it is not limited thereto. The access control apparatus 100 according to the present embodiment can support various kinds of remote access by having a communication-server functional unit that is compatible with a communication-client functional unit in the communication terminal 300 such as the block access server 102 and the file transfer server 103. In this case, the access control apparatus 100 can perform access control on the device IF 107 and respective mounted communication-server functional units.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An access control apparatus, comprising:
a determiner configured to determine whether an access state of a first device to a storage device satisfies an exclusion criterion for access to the storage device from a second device; and
a controller configured to prohibit the access to the storage device from the second device when the access state of the first device satisfies the exclusion criterion.

2. The apparatus according to claim 1, wherein
the determiner is configured to determine whether an access state of host access from the first device that is connected to the storage device satisfies the exclusion criterion for remote access to the storage device from the second device that accesses the storage device through a predetermined communication mode.

3. The apparatus according to claim 2, wherein
the determiner is configured to determine that the access state of the host access satisfies the exclusion criterion for the remote access when the access state of the host access indicates a state where disconnection from the storage device is prohibited.

4. The apparatus according to claim 3, wherein the state where disconnection from the storage device is prohibited indicates a state where the storage device is under control by an operating system being in operation in the first device.

5. The apparatus according to claim 2, wherein the determiner is configured to determine that the access state of the host access satisfies the exclusion criterion for the remote access when the access state of the host access indicates a state where disconnection from the storage device is allowed and time equal to or longer than an operation time interval of last successive data writing to the storage device has not elapsed since the first device performed the last successive writing to the storage device.

6. The apparatus according to claim 5, wherein the state where the disconnection from the storage device is allowed indicates a state where the storage device is released from the control by the operating system being in operation in the first device.

7. The apparatus according to claim 1, wherein the determiner is configured to determine whether an access state of remote access to the storage device from the first device through a predetermined communication mode satisfies the exclusion criterion for host access from the second device that is connected to the storage device.

8. The apparatus according to claim 7, wherein the determiner is configured to determine that the access state of the remote access satisfies the exclusion criterion for the host access when the access state of the remote access indicates a state where disconnection of a communication session established between the access control apparatus and the first device is prohibited.

9. The apparatus according to claim 8, wherein the state where disconnection of the communication session is prohibited indicates a state between start and end of connection or a state between start and end of a file reading and writing request.

10. The apparatus according to claim 1, wherein the determiner is configured to determine whether an access state of remote access to the storage device from the first device through a first communication mode satisfies the exclusion criterion for remote access to the storage device from the second device through a second communication mode.

11. The apparatus according to claim 1, wherein
the controller is configured to notify the second device of prohibition of access to the storage device by any one of an error response, a busy response, and suspension of processing by sending no response.

12. The apparatus according to claim 1, wherein the controller is configured to perform control such that access to the storage device from the first device or access to the storage device from the second device is given higher priority, based on a predetermined priority sequence.

13. The apparatus according to claim 12, wherein the controller is configured to instruct the first device to release the storage device from control by an operating system being in operation in the first device when remote access to the storage device from the second device through a predetermined communication mode is given higher priority than host access from the first device to which the storage device is connected.

14. The access control apparatus according to claim 1, further comprising the storage device.

15. An access control method, comprising:
determining whether an access state of a first device to a storage device satisfies an exclusion criterion for access to the storage device from a second device; and
prohibiting the access to the storage device from the second device when the access state of the first device satisfies the exclusion criterion.

16. A computer program product comprising a computer-readable medium containing a program executed by a computer, the program causing the computer to execute:
determining whether an access state of a first device to a storage device satisfies an exclusion criterion for access to the storage device from a second device; and
prohibiting the access to the storage device from the second device when the access state of the first device satisfies the exclusion criterion.
